(19) United States
(12) Patent Application Publication
(10) Pub. No.: US 2009/0017319 A1
(43) Pub. Date: Jan. 15, 2009

(54) Metallised parts made from plastic material

(75) Inventor: Antoine Fares-Karam, Besancon (FR)

Correspondence Address: HARRINGTON & SMITH, PC, 4 RESEARCH DRIVE, Suite 202, SHELTON, CT, 06484-6212, US

(73) Assignee: FCI

(21) Appl. No.: 12/283,784

(22) Filed: Sep. 15, 2008

Related U.S. Application Data
(62) Division of application No. 10/517,041, filed on May 20, 2005.

(30) Foreign Application Priority Data
Jun. 6, 2002 (FR) 0206955

(51) Int. Cl. C23C 18/52; C23C 18/22; C23C 18/32; C23C 18/38; B32B 15/08

(52) U.S. Cl. 428/457; 427/534

(57) ABSTRACT

In order to metallise a support made from high temperature polymer, the melting temperature of which is higher than 180° C., it is shown that the stages of cleaning, plasma etching, grafting and then metallising in a metallisation bath can be applied. According to the invention, the metallisation bath is brought to a temperature between 50° C. and 70° C., the plasma being a nitrogenous plasma.

The object of the present invention is parts that are metallised and made from plastic material. The parts are metallised in a process for metallising support media made from plastic material, particularly from high temperature plastic material. The aim of the invention is, particularly for the electronics industry, to facilitate the production of connectors and more generally support media that are resistant to high temperatures and serving as hybrid mountings, which are light, easy to manufacture, and which have high electrical insulation properties, while allowing necessary electrical conduction by metallising.

A process for creating metallised circuits in two or three dimensions by a process of sandwich moulding is known particularly from U.S. Pat. No. 5,407,622, particularly using a first mould of a plastic material and subjecting it to an activation stage that renders is capable of being metallised, a second mould of a plastic material which does not lend itself to metallising, leaving the activated zones of the first piece exposed, and then a metallising stage. The description of this process indicates that the adhesion promotion stage (activation) uses chemical oxidation by a solution that renders the plastic surface hydrophilic. U.S. Pat. No. 4,812,275 also relates to a sandwich moulding process. For this process, adhesion is promoted by chemical etching to roughen the surface to be metallised.

A further method, for which a catalyst precursor is deposited, is described in U.S. Pat. No. 5,153,023. According to that document, selective metallising is achieved by locally heating those zones where it is desired to attach the catalyst and rinsing the piece to dissolve the precursor in the places where metallising is not desired.

An earlier sandwich moulding technology is described in British Patent No. GB-A-1 254 308. According to this document two materials are used, one of which being suitable for metallising, the other not. The composite article is then treated by a metallising process including a chemical etching stage of the item's surface, a treatment stage, then a stage in which an electrochemical catalyst is deposited.

Typically, chemical techniques exist for cleaning, sensitising and activating a surface to be coated. Immersion processes are implemented in specific baths in order to affix palladium seed crystals to the surface. These conventional techniques may be summarised as follows: a surface preparation stage, including cleaning and stripping, is followed by adsorption of a catalyst and then metallising.

The prior treatments use chemical solutions. Thus each type of plastic has its own specific surface preparation range. The major drawback of these treatment ranges is that they include a large number of steps, from 16 to 22 depending on the nature of the polymer. On the other hand, these multiple stages require a rather long processing time, in some cases up to 65 minutes, before metallising can even begin. Consequently, treatment of the plastic substrates for metallising is difficult, complex and expensive, particularly several types of polymer material are to be metallised. These processes also entail expensive reprocessing of the solutions. Moreover, the activation or catalysis solutions used in these processes chiefly use colloidal palladium-tin (PdSn) solutions, which are costly, polluting, and highly sensitive to temperature fluctuations. For example a temperature below 10° C. can partially or completely deactivate these activation solutions and render them unusable. On the other hand, the use of etching and engraving solutions renders the plastic surface somewhat rough, which means that it is not usable for certain applications in connection, precision soldering, electronics and packaging which require very level and very smooth surfaces. It should be noted that this roughness is necessary in the case of conventional methods in order to assure good mechanical adhesion. It must also be pointed out that very many high temperature technical plastics, particularly those used in connection applications, such as LCP, PPS and PBT, are considered to be incapable of being metallised by the conventional wet chemical methods described in the aforegoing. This severely limits the possibilities for opportunities for taking advantage of the characteristics of these polymers on an industrial scale. Some grades of these plastics contain very specific additives (compounding) to render them suitable for metallising by chemical means but this degrades their mechanical performance and dielectric properties. As a result, they become unsuitable for use in connection.

The disadvantages of these procedures are therefore the slowness of the chemical processes, the number of stages required, the use of costly and polluting colloidal solutions of palladium, the impossibility of metallising high temperature technical plastics, the roughness created at the site of the metallised part and the risks of peeling in the case of a smooth surface. In fact, in these cases the metallisation is a result of mechanical adhesion, and is not sufficiently bonded.

In order to resolve these problems in the invention, it was decided to use a nitrogen or ammonia plasma in order to achieve chemical adhesion of the metallic deposit on a smooth material. Nitrogen or ammonia plasma is produced in a vacuum bell accommodating the article to be metallised. A primary vacuum is created in the vacuum bell, a gas is injected, either one of NH₃, N₂, or (N₂+H₂), or a mixture of these gases. Plasma is obtained with electromagnetic energy (low frequencies, radio frequencies), by microwave or by microwave discharges.

Activation trials of certain plastic materials by a plasma have been conducted and are known from the following documents: “Interest of NH₃ and N₂ Plasmas for Polymers Surface Treatment Before Electroless Metallization”, which appeared in Plasmas and Polymers, Vol. 1, N^{o}2, 1996, pages 113-126, courtesy of M. ALAMI, M. CHARBONNIER, and M. ROMAND, D1, “Plasma Chemical Modification of Polycarbonate Surfaces for Electroless Plating”, which appeared in J. Adhesion, Vol. 57, Pages 77-90, by the same authors, D2, “Surface plasma functionalization of polycarbonate: Application to electroless nickel and copper plating” M. Charbonnier, M. Romand, E. Harry, M. Alami; Journal of applied electrochemistry, January 2001, Volume 31, N^{o}1, pages 57-63, D3, “Electroless Plating of polymers: XPS study of the initiation mechanisms”; M. CHARBONNIER; M. ALAMI and M. ROMAND; Journal of applied electrochemistry, April 1998, Volume 28, N^{o}4, paged 449-453, D4, “Plasma Treatment Process for Palladium Chemisorption onto Polymers before Electroless Deposition”, Charbonnier, M.; Alami, M.; Romand, M., Journal of the electrochemical society, 1996, Vol. 143, no. 2, pp. 472-480, D5.

However, while it is true that the first document D1 does conceive of such a treatment for polymers in general, yet it describes as a practical example only amorphous polystyrene, polycarbonate and polyamide whose support qualities in the electronics domain are of little interest because of their temperature limits and the high rate of water absorption of the polyamide.

The second, third and fourth documents, D2, D3 and D4, provide an account only of the details for the treatment of polycarbonates and the mechanisms thereof. These materials are not significant in the field of electronics and components because of their mediocre qualities in terms of thermal resilience, electrical insulation, industrial workability, and mechanical suitability.

In contrast, in the field of electronic circuits and connectors, plastic materials with high thermal resilience are preferred, of the semi-crystalline and/or liquid crystal type, typically in polyester, polybutylene terephthalate (PBT), or in LCP, of polyphenylene sulphide (PPS) type, or syndiotactic polystyrene (SPS) type.

These polymer plastic materials may be qualified as high temperature polymers because their melting temperatures are 220° C. for PBT, and higher than 350° C. for the three others listed above.

By comparison the melting temperatures of the other polymers recognised as suitable for metallising by plasma or other process are much lower, in the region of 90° C. for the ABS or PVC, and 120° C. for polycarbonate.

However, high temperature technical plastic materials are known for their inertness with respect to the chemical treatments associated with metallising. This inertness is significantly reinforced in cases where these plastics are partially crystalline. This has had the effect of limiting attempts at metallising these high temperature materials.

As for document D5, this covers the precisely same work as D1 on polycarbonate and amorphous polystyrene. In addition, the authors indicate unequivocally that the maximum thicknesses attained by their methods are less than 2 μm. This is evidently not usable in industrial connection applications where metallic films having a thickness greater than 20 μm are often required.

A further observation tending to discourage experts from using the plasma process is the use by the authors of documents D1 to D5 of a particular type of laboratory nickel-plating bath, which only operates at temperatures above 85° C., has an acidic pH, and decomposes systematically, as they indicate particularly in document D4. This significantly limits the choice of metallising baths and does not allow of operation on an industrial scale.

Moreover, metallising experiments carried out in the laboratory on the high temperature polymer materials noted previously with plasma activation methods, particularly the method described in documents D1 to D5, yield poor or at the very least inconsistent metallising results. Use of industrial metallising baths with the activation plasma described in these same documents does not allow of any metallising on high temperature plastics or on the low temperature plastics described in these same documents. From these findings, it is generally accepted these technical plastic materials do not lend themselves to metallisation by these plasmas.

An even more discouraging effect with regard to metallising high temperature plastic materials is the fact that these materials are generally filled with additives (fillers and compounds), such as fibreglass for example, which are used extensively in the industry. Glass fibres have the effect of increasing the inertness of plastics with respect to the various activation methods. This serves to explain the inconsistent nature of the process described in these documents.

In spite of this a priori condition and in order to solve these problems, within the scope of this invention we began research the conditions under which “Electroless” metallising might be conceivable with prior etching by plasmas.

Electroless metallising of such kind, that is to say without the use of an electrical current, particularly includes 1) degreasing of the substrate, 2) etching by plasma, 3) activation of the support surface particularly by immersion in a dilute solution of palladium chloride, rinsing with water, 4) chemical reduction by a hypophosphite or formaldehyde bath, and 5) the actual metallising process. This metallisation includes immersion in a metallising bath.

Although the first experiments were unsuccessful, as recalled above, we discovered that the expected metallisation did not occur under ideal conditions if the various baths used were not properly primed. We therefore proceeded to prime them systematically and were then able to record that metallisation took place thereafter in a satisfactory manner. Priming the baths specifically involves immersing in these baths a piece of nickel, a panel freshly stripped in a solution of HCl.

Then we turned our attention to eliminating the need for priming, and we then found that the temperature of the baths had to be monitored more closely. We thus discovered that the metallising baths, which according to the prior art were heated to 85° C., had to have a temperature between 50° C. and 70° C., preferably between 55° C. and 65° C.

In order to control this temperature better during metallising, we specifically chose very large baths relative to the volume of articles to be treated, so that the immersion of these articles in the bath would not affect its temperature too much. Another solution from this point of view might consist in preheating the items to be treated.

According to the invention, and in order to further improve metallisation without recourse to priming, and to better activate the high temperature technical materials, we mixed an inert, noble gas such as neon, helium or argon with the gas used for the plasma (N₂ or NH₃). The inert gas is added in a proportion of 0.1 to 6% by volume which increases the dissociation of the nitrogen and/or the ammonia or mixtures thereof in reactive compounds of 7 to 8% into free radicals and excited ionic or atomic moieties.

The activation time is the range from 5 seconds to 5 minutes and the power density varies between 0.1 and 1.1 W/cm², preferably between 0.3 and 0.7 W/cm². The electromagnetic activation frequency may be in the range from 75 Hz to microwave. The activation has the effect of breaking the carbon and carbon-hydrogen bonds on the article and grafting nitrogenous NH, NH₂, N₂⁺, . . . , compounds, and more generally amides, amines, imines or imides.

The piece may then be immersed in an ionic solution containing palladium salts (for example PdCl₂ or PdSO₄+HCl), which enables grafting of the palladium ions. This palladium will then be reduced chemically in a bath containing a reducing agent as such hypophosphite, formaldehyde, or hydrosulphite. This grafting followed by reduction then provides the conditions so that when the grafted article is immersed in a chemical metallisation bath, a first, thin metallising layer is deposited, which will then be supplemented to yield a thick metallising coat by electrochemical or galvanic deposition. A characteristic of the resulting product is that nitrogenous and palladium compounds are found by analysis at the metal/polymer interface, the thick metallising layer having a thickness preferably between 0.2 μm and 20 μm.

Within the scope of the invention, the process has been extended to include materials originally considered not to be susceptible to metallising according to the state of the art such as the PBT, PPS, SPS, and LCP. Ultimately, it has proven possible to metallise these materials according to the process and according to the refinement of the invention.

Moreover, the plasma etching process may be controlled so as to enable selective metallisation on an item formed from two different plastic support media, without an activation stage between the two moulding stages. In effect, by virtue of this selective metallisation, it is possible to provide for the activation of one part of an article, to glue or remould another, unactivated part of the article onto this activated part, and then to metallise the whole, such that the metallisation only takes place on the prepared part (as indicated in U.S. Pat. No. 5,407,622). Thus the need for an engraving operation would be dispensed with. However, this technique, which includes manipulation of an activated part, may entail local deactivation of this activated part during the gluing or remoulding of the unactivated part, particularly in the presence of pollutants and contaminants such as greases and oils.

According to the invention, this problem was solved in that the gluing or remoulding of the two parts was carried out before the activation, but using different plastic materials for these different parts. Then, at the time of the plasma activation, the conditions of activation are modified, so that only one of the two parts is activated. Typically, the duration of the activation is modified. For example, it is limited to 10 seconds (or a duration less than 15 seconds), since a part made from LCP or SPS is activated in 5 seconds whereas the other part, made from PBT or PPS respectively, which only becomes activated after 60 seconds, is not activated. In fact, experiments have been conducted with a piece including both PBT and SPS and one including both PPS and LCP.

On the basis of these experiments, it was possible to determine that optimising the plasma parameters (time and energy) gave rise to a grafting reaction that was sufficiently differentiated so that after the grafting stage of the palladium ions, it was possible to perform selective metallisation by a first layer in a bath of auto-catalytic chemical copper with stabilising agents. It is therefore evident that the improvement of the process of the invention consists in bringing about a differential activation of a bi-material product thereby permitting selective metallisation, particularly by a rapid metallisation stage.

An object of the invention, therefore, is a process for metallising an article made from high temperature polymer plastic material including the steps of cleaning, plasma etching, grafting, and then metallising by immersion in a metallisation bath, for which the metallisation bath is brought to a temperature between 50° C. and 70° C.

A further object of the invention, therefore, is a process for metallising an article made from high temperature polymer plastic material including the steps of cleaning, plasma etching, grafting, and then metallising by immersion in a metallisation bath, such that the metallisation bath is previously primed.

Another object of the invention is a process for metallising an article made from high temperature polymer plastic material including the steps of cleaning, plasma etching, grafting, and then metallising by immersion in a metallisation bath, for which the article includes parts made from different plastic materials, and such that the operating conditions of these steps are regulated so that the grafting and then the metallising are effective on one of these parts and not on the other.

The main object of the invention is a plastic piece at least partially coated with a metallic deposit including a first, non-metallised plastic material,
a second plastic material at least partially coated by the metallic deposit, the metallic deposit includes attachment sites including nitrogenous and palladium moieties at the interface with the second material, includes a first layer called the initial layer having a first thickness, includes at least a second layer called the external layer having a second thickness, the first and second plastic materials having no metallic or catalytic charges.

Still in accordance with the invention, the part is such that the interface is constituted on the second material by plasma activation of at least this second material followed by immersion of the piece in a bath of ionic palladium.

In order to create the piece according to the invention, the plasma activation is performed on the two plastic materials for a duration which only activates one of the plastic materials.

According to a special mode of the invention, the plasma activation activates both materials, and a deactivation stage of one of materials is placed between the activation and the immersion stages, the deactivation stage may be a waiting or ageing stage.

In an alternative mode, the plasma activation is applied to both materials, oxygen being added for example by stirring the bath, agitation, insufflation of air or bubbling during a chemical deposition stage subsequent to the immersion of the piece in the ionic palladium bath to form the initial layer on only one of the plastic materials.

According to the invention, the first and second materials may be chosen from the materials SPS, LCP, PBT, PPS and their various catalytically uncharged grades. After treatment, the first and second plastic materials may form a non-metallisable/metallisable pair selected from LCP/SPS; PBT/LCP; PBT/SPS; PPS/LCP; PPS/SPS; PBT/SPS.

The external layer may particularly be created by electrochemical deposition of a metal such as copper or nickel.

The thickness of the initial layer may start from a thickness of 0.3 μm and reach a thickness of 20 μm, but is advantageously between 0.3 μm and 1.5 μm, the external layer preferably having a thickness between 4 μm and 30 μm.

The piece according to the invention is such that the adhesive force of the deposit on the second plastic material is greater than 1 N/mm² and especially the adhesive force of the deposit on the second plastic material may be greater than 2 N/mm².

Still in accordance with the invention, the surface of the second material after the deposit is stripped off displays a spectral analysis provided at least with peaks corresponding to nitrogen moieties, peaks corresponding to palladium moieties, and presents an offset of the peaks corresponding to the palladium moieties specific to PdNₓ bonds.

The invention will be better understood with reference to the following description and the figures that are attached thereto. These are presented purely for exemplary purposes and are in no way limiting of the invention. The figures show:

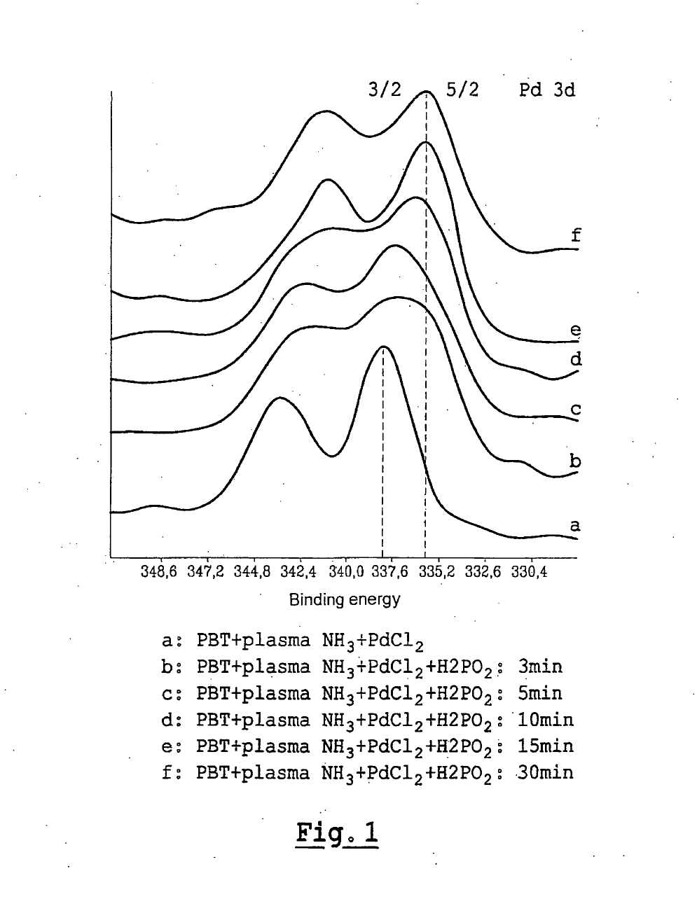

FIG. 1: the evolution of the energy position of the spin doublet of palladium 3d;

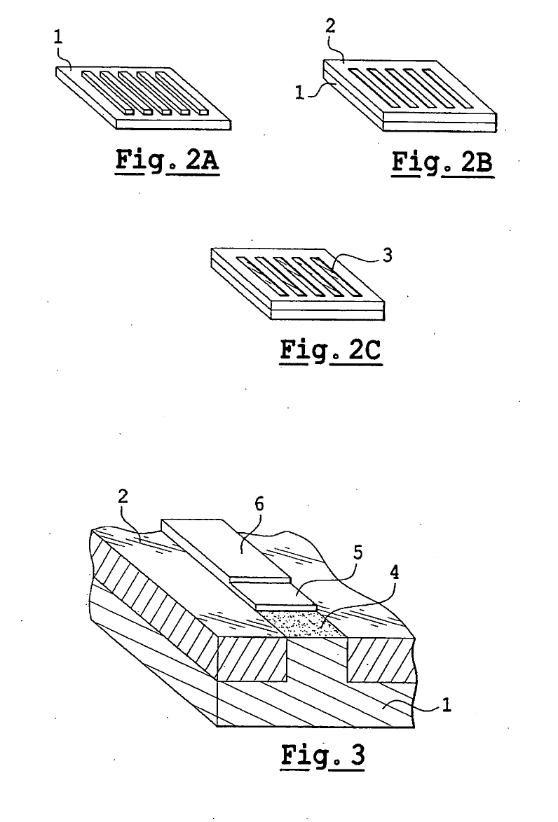

FIGS. 2a, 2b and 2c: an example of a part according to the invention for the moulding activation stages;

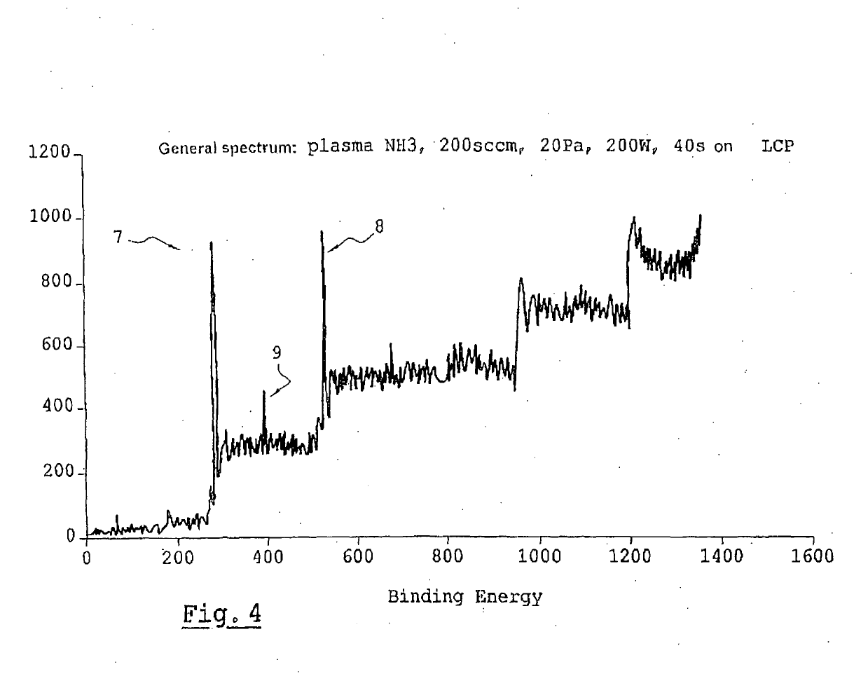

FIG. 3: a detail view of the part according to FIGS. 2A, 2B, 2C after metallisation;

FIG. 4: a representation of the XPS spectrum of the plastic metal interface surface of a part according to the invention;

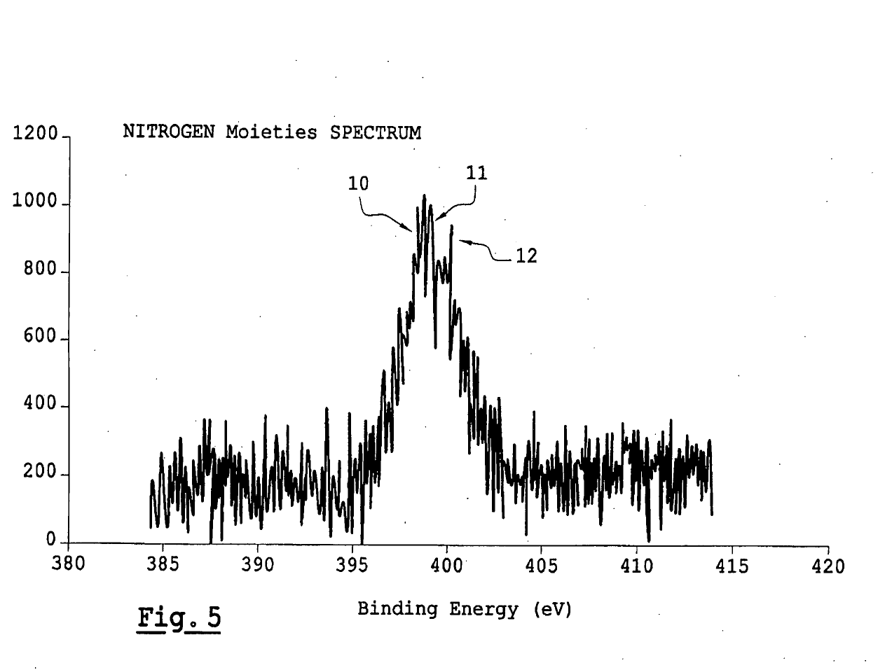

FIG. 5: a first detail of the representation of FIG. 4;

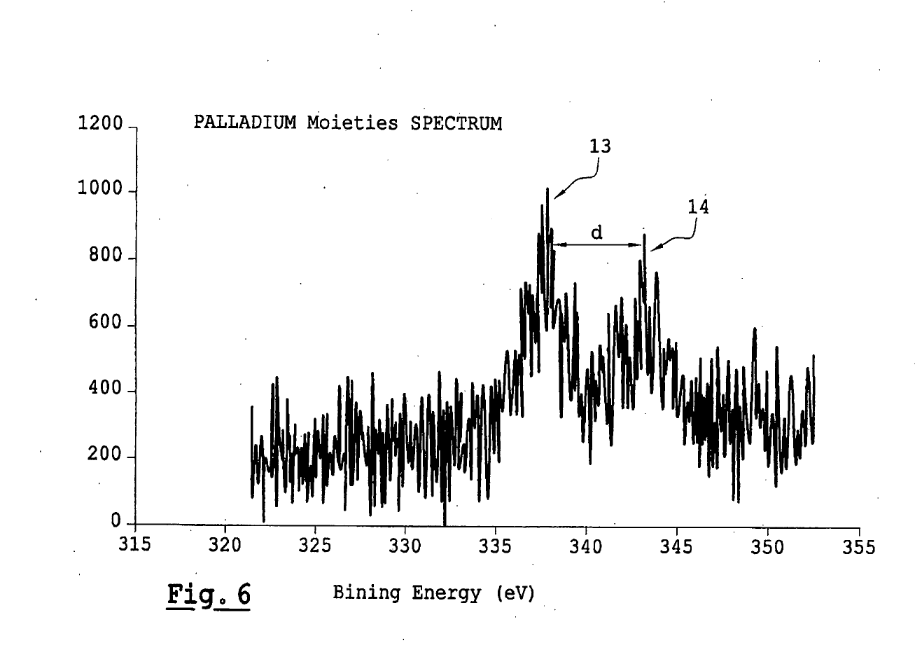

FIG. 6: a second detail of the representation of FIG. 4;

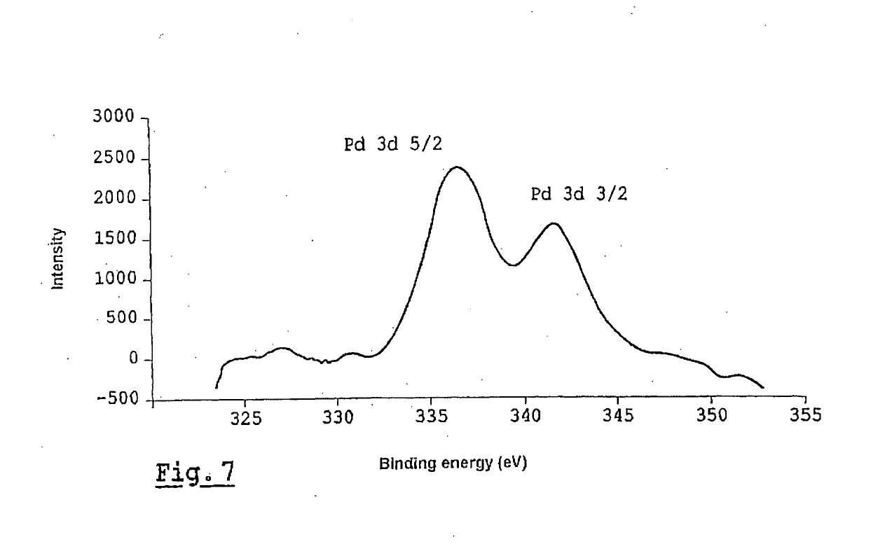

FIG. 7: a statistical representation of a detail of the XPS spectrum of the interface surface of another part type according to the invention;

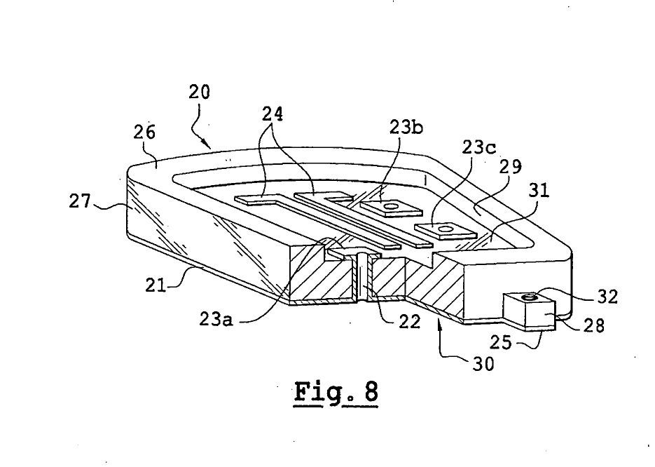

FIG. 8: a schematic cross-section view of a part including a single plastic material metallised according to the process of the invention.

The plasma technique used in the scope of the invention consisted in creating a high-frequency potential gradient in a gas under reduced pressure. Different moieties are then created, including: electrons, ions, atoms and molecules either excited or not, free radicals, UV and visible photons.

In practice the three excitation frequencies used to create this plasma are in the low frequency range (<100 Hz) the radio frequency range (13.56 MHz) and the microwave range (430 MHz or 2.45 GHz).

The plasma used is a nitrogenous plasma for example of type N₂ or NH₃ or N₂+H₂, which forms C—N type groupings on the polymer surface. The plasma is also a highly reactive composite which has numerous effects on the surface of the substrate, including:
cleaning of the surface, by elimination of organic contaminants,
stripping which removes surface layers by creating a certain roughness at the nanometric level on the substrate surface.

In addition, the plasma UV breaks the C—C and C—H bonds of the polymer, thus enabling the free radicals to react with other radicals of the gas or with other macromolecular chains of the surface.

One effect achieved within the scope of the invention by the use of a nitrogenous plasma is functionalisation which is a grafting of chemical functions achieved with a reactive gas plasma: grafting of nitrogenous functions (N₂, NH₃ plasma) to the surface of the polymer. Nitrogenous N₂ plasmas enable the following groupings to be obtained: H₂N—C amines, N═C imines, N—C nitriles. NH₃ plasmas lead to the formation of the following groupings: H₂N—C amines, N—C═O amides.

A second stage in obtaining a metallised high temperature plastic within the scope of the invention is Electroless metallisation. Electroless metallisation is a process of chemical deposition of metallic layers on substrates from an aqueous solution, without the use of an external current source. This is a method operating without an external electric source. The baths or solutions used in order to obtain the metallic deposits are industrial solutions devised by specialist companies. The baths are made up of several agents, including in particular:
a metal salt for deposition: Ni, Cu, Ag, Co;
a reducer: sodium hypophosphite, formaldehyde;
a stabiliser;
a pH regulator, and;
a sequestering agent.

The metallic deposition reaction is the result of an oxidation-reduction reaction between a metallic ion to be deposited and the system's reducer. In order to obtain a deposition on the surface of any substrate, it is necessary to render this surface active, which is to say catalytic for the redox reaction so that the reduction of the metallic ions can be initialised. If the substrate is non-conductive, as in the case of polymers, it is necessary to produce nucleation sites on the surface thereof. This is done by fixing a salt of a metal of group VIII (generally palladium) in order to be able to initiate the deposition reaction. Consequently, such an approach has been implemented in the invention in order to modify the surface of the substrate by a plasma treatment.

Thus according to the invention, by subjecting a substrate, particularly a connection element consisting of a polymer to a plasma of type N₂ or NH₃ or (N₂+H₂), C—N type groupings are formed on its surface. When this sample is then immersed in a bath of palladium: PdCl₂ or PdSO₄, strong covalent bonds are created between the nitrogen and palladium atoms: C—N—Pd; the surface is thus activated, which enables the oxidation-reduction reaction described previously to begin. A first advantage of the process of the invention is that this simplified treatment eliminates the chemical treatments for surface conditioning and the sensitisation treatment with stannous chloride known in the prior art, in which handling the solutions is difficult and expensive.

This simplified process, which will be described in the following, may be summarised by the following organisational chart: degreasing by solvent, etching by plasma, activation, rinsing and metallisation.

As was indicated previously, in order to modify the surface of the polymers, we used “non-polymerisable” gases: N₂, NH₃, enabling nitrogenous chemical functions to be grafted. The plasma treatments were carried out, in non-limiting terms, by using a radio frequency RF reactor of 13.56 MHz with parallel aluminium electrodes, operating in capacitive mode. The connector substrate to be treated is arranged on a lower electrode, the cathode, which is connected to the RF generator. The upper electrode, the anode, connected to earth, is perforated with holes, which allows a homogenous flow of gases at the reactor inlet. A water circulation system cools the two electrodes continuously, thus ensuring that they are not heated above 60° C. The efficiency of the plasma treatments depends on various operational parameters, we concentrated our efforts on varying these parameters in order to optimise the metallising conditions:
Gas pressure in the reactor: 0.12 Pa to 35 Pa;
Gas flow: 10 to 1000 sccm;
Gases used: NH₃, N₂, (H₂+N₂) as main gas and in certain cases noble gases such as helium, argon and neon were added;
Duration of treatment: 0.5 sec. to 10 minutes;
Power: a power density provided by the generator: 0.1 to 1.1 W/cm².

The Electroless baths most commonly used in industry contain the salt of the metal for deposition, a powerful reducing agent, a sequestering agent for the metallic ion and a stabilising compound to prevent the solution from decomposing. For the purposes of the invention, we used two baths manufactured by Enthone-OMI. A first bath to deposit nickel: Enplate Ni426 contains little phosphorus. A second bath to perform the copper deposition: Enplate Cu872.

For all non-conductive materials such as polymers it is necessary to render the surface catalytically active by creating nucleation sites thereon by grafting of a noble metal, such as palladium that is capable of catalysing the reaction. Here we use palladium because it has a very strong affinity with nitrogen, previously fixed by plasma treatment.

We used three solutions to metallise samples, namely:
a palladium chloride bath containing between 0.05 g/l and 0.5 g/l PdCl₂, from 1 to 30 cm³/l pure HCl, in order to assure the adsorption of the catalyst (immersion from 0.5 to 5 minutes followed by rinsing with water for about 30 sec);
as a reducing bath we used a sodium hypophosphite bath operating between 50 and 85° C., or a formaldehyde bath in a sodium hydroxide medium, or a hydrosulphite bath in an alkaline medium to assure chemical reduction of the catalyst grafted to the surface of the substrates (immersion from 1 min to 10 mins). This stage is optional and its use depends on the stability of the industrial baths. In fact, the reduction of the Pd²⁺ moieties by the chemical reducer before the metallisation stage enables this to begin quickly and yields good quality deposits;
a metallisation bath containing the salt of nickel or copper (immersion for a variable duration depending on the desired thickness of metal).

The Electroless metallising procedure may be summarised as follows in exemplary manner for a substrate of PBT+30% fibreglass:
Degreasing: isopropanol with ultrasound or alkaline degreaser
RF plasma (0.5 sec to 10 min)
Immersion in the PdCl₂ bath
Rinsing: distilled water
Immersion in the hypophosphite or formaldehyde bath
Immersion in the metallisation bath
Rinsing.

In order to degrease the parts, for example plastic connector boxes are placed in an isopropanol bath with ultrasound or in an alkaline degreaser bath containing a surfactant and sodium hydroxide.

Baths containing the hypophosphite and the nickel are each brought to a temperature between 50 and 65° C. After the grafting of nitrogenous functions onto the polymer: C—N bonds, it is activated by PdCl₂ by attaching palladium seed crystals thereto. Since the palladium has a strong affinity for nitrogen, C—N—Pd type bonds are created, the palladium thus fixed is in the Pd(II) state. The palladium must be in the Pd(0) state to be active. This is achieved by exposing the grafted substrates to the direct action of a reducer (immersion in a hypophosphite bath) or to the action of the metallisation bath itself (bath containing hypophosphite).

The surfaces thus prepared are then analysed. To characterise the surface of insulators, particularly the surfaces of polymers, one possible technique is X-ray photoelectron spectroscopy: XPS. The advantage of this method is that it can reveal the presence of certain chemical bonds on the surface. Another test method such as secondary ion mass spectrometry (SIMS) allows characterisation of the peaks corresponding to the chemical moieties existing on the material surface.

The wettability of items was also measured using a Digidrop equipment manufactured by GBX Scientific Instruments that includes a camera, an image processing and analysis system associated with software permitting the automatic measurement of the contact angle.

Adhesion tests were also performed by removal of an adhesive tape, commonly known as the Scotch test (Scotch is a registered trademark of 3M) the adhesive tape used is 3M Type 250. This test consists in making separate intersecting incisions (a grid) on the metallising deposit. These incisions must be deep enough to reach the substrate. Then an adhesive tape is firmly attached to the incised surface. After 3 minutes, the adhesive tape is ripped off very quickly, in a single movement. In general, testing is done at an angle of 180°. The incised part of the coating under test is then examined. A standardised classification in six categories is used to estimate the adhesion of the deposit on the substrate.

The next test in the sequence is a ripping test by traction. During this test, adhesion is measured by the tensile force it is necessary to exercise on the deposit, perpendicularly to the interface plane, in order to pull it away from its substrate. A cylindrical contact block made from aluminium is glued to the coating using a cyanoacrylate type adhesive. With the substrate immobilised, the contact block is pulled away using a traction machine which records the maximum force required to detach a disc from the coating. The ratio between this maximum force and the surface of the contact block is often used to characterise the adhesion:

It is necessary to wait 24 hours for drying at ambient temperature before proceeding to the traction test.

The substrates studied are parts for usage in connections or MID type circuits (moulded interconnect devices). These are for example connector boxes coated for example with a metal layer forming unconnected conductive paths that enable electricity to be conducted or constituting an electromagnetic insulation. This layer of metal must not be altered, nor detach due to industrial or environmental stresses such as are encountered in a car for example. The metallised parts must particularly withstand significant electrical stresses without damage to the substrate surface. The ability to withstand electrical stresses is measured by thermal shock testing. These tests are of two types: classic thermal shocks or cyclic thermal shocks. These thermal shocks are used to verify the ability of the deposit to withstand significant thermal fluctuations and therefore electrical shocks which generate a temperature rise in the conductive metal. By verifying the holding ability of the metallic deposit on the substrate following a thermal shock, it is possible to validate the resistance of the sample to electrical shock.

As part of the process of electronic component manufacturing, the materials for connectors on which nickel and copper must be deposited to create conductive paths, are for example the following:
PBT+30% glass fibres (polybutylene terephthalate), called industrially Pocan;
LCP (liquid crystal polymer), called industrially Vectra;
SPS+30% glass fibres, called industrially Questra;
PPS polyphenylene sulphide+40% glass fibres (for example RYTON made by Chevron Phillips).

We have therefore studied each of these plasma treatment parameters: the treatment time, the generator power, the gas flow and pressure. In order to optimise the parameters of the plasma, we characterised the surface of each of the samples treated by measuring the wetting angle and by XPS analysis.

### Substrates of PBT Charged with 30% Glass Fibres

We studied the influence of the treatment time, the power, the gas flow and gas pressure. We also concerned ourselves with the influence of the kind of gas: NH₃ or N₂ and mixtures thereof with a noble gas, in this case neon.

The wetting angle was measured for each connector treated. The results of these measurements permit us to track the change in the wetting angle depending on the parameter studied.

The value of the wetting angle for a sample of untreated PBT charged with 30% fibreglass is 83.6°. A treatment from 180 secs to 240 secs proved to be ideal, and decreased the angle value by about 10°.

By way of example, the treatment parameters (T1) permitting the initiation of a metallic deposition on the sample for this type of polymer are:
Treatment time: 240 seconds
Gas type: N₂ (95%)+Ne (5%)
Power 0.2 to 0.3 W/cm²
Flow: 350 sccm (ml/min)
Pressure: 25 Pa

A second treatment (T2) with another gas also permits initialisation of metallic deposition:
Treatment time: 300 seconds
Type of gas: N₂ (90%)+H₂ (10%)
Power 0.8 to 0.9 W/cm²
Flow: 350 sccm (ml/min)
Pressure: 25 Pa

In conclusion, the parameters of the plasma treatment, pressure and flow, the treatment time and the power delivered by the generator are optimised according to the gas used (NH₃ or N₂) for the treatment, but also as a function of the noble gas used. A noble gas promotes the dissociation so that less power is required. On the other hand, using a nitrogen and hydrogen mixture requires more power and more treatment time to assure the graft.

The XPS analysis of sample parts, provides information on the way the polymer surface has been modified. For each plasma treatment, we analysed two representative samples of connectors made from PBT. Each connector is immersed for 4 minutes in the PdCl₂ bath, then rinsed in water. Knowing the palladium's affinity to the nitrogenous functions previously fixed on the surface of the polymer we would expect to find traces of palladium when analysing the surface of the sample by XPS. The proportions of each of the atoms present on the surface of samples are calculated. We summarised the result of analysis in the chart below. The values given correspond to the atomic percentages.

| Samples | % C | % O | % N | % Pd | % Cl |
|---|---|---|---|---|---|
| PBT with treatment T1 | 67 | 23 | 5.8 | 3 | 1.2 |
| PBT with treatment T2 | 67.9 | 23.0 | 3.6 | 3.2 | 0.5 |

We note that treatment T1 grafts more nitrogen than treatment T2 but that the level of grafted palladium remains equivalent.

### LCP Substrates

In a second stage, we took the same measurements on another polymer: LCP, after different plasma treatments. The connectors fabricated with this plastic are intended for very high temperature applications (continuous operation at 190° C. and soldering at 245° C.). We characterised the surfaces of treated samples.

We performed summaries of the wetting angles for the different treatments performed. This enabled us to evaluate the influence of the experimental parameters on the wettability of the substrate.

The value of the wetting angle for an untreated LCP sample is 78.8. After a treatment of 15 seconds the wetting angle decreases significantly to 40.2°. From 30 seconds onwards the wetting angle tends to flatten out, with average wetting angle values of about 12°. For treatment times longer than 240 seconds, the polymer has a tendency to deteriorate.

The LCP is sensitive to the treatment, so short times are required, unlike the PBT.

By varying the flow and pressure parameters, kind of gas, treatment time and power, it is possible to perform plasma treatment for LCP.

For the purposes of example, the treatment parameters for LCP (T3) allowing the initiation of a metallic deposition on the adherent sample for this type of polymer are:
Treatment time: 20 seconds
Gas type: N₂ (96%)+Ar (4%)
Power 0.15 to 0.20 W/cm²
Flow: 200 sccm (ml/min)
Pressure: 22 Pa

A second treatment for LCP (T4) with another gas also permits initialisation of metallic deposition:
Treatment time: 35 seconds
Gas type: NH₃
Power 0.2 to 0.25 W/cm²
Flow: 50 sccm (ml/min)
Pressure: 25 Pa

The surface analysis of these samples by XPS shows that, after immersion in a bath of ionic palladium, a reduction bath with a formaldehyde base in sodium hydroxide medium yields a surface having the following atomic composition:

| Samples | % C | % O | % N | % Pd | % Cl |
|---|---|---|---|---|---|
| LCP with treatment T3 | 66.5 | 21.7 | 7.2 | 3.4 | 1.2 |
| LCP with treatment T4 | 67.1 | 22.4 | 6.7 | 2.9 | 0.9 |

The T4 treatment grafts less nitrogen and less palladium than T3, but it is sufficient to trigger an adhesive metallic deposition on connectors made from LCP.

After optimising the plasma parameters to enable the surface state to be modified, it is important to confirm that the modified substrate is metallised correctly and in reproducible manner, particularly by Electroless nickel metallising. Initially, we used the nickel bath made by Enthone. In order to optimise the metallisation of the substrate with this bath we conducted some studies beforehand. These studies were carried with the intention of gaining a homogenous and reproducible metallisation of the modified substrate. For that, we studied the influence of:
the composition of the Enthone bath (proportions of the different constituents, pH of the initial solution and during the deposition)
the substrate cleaning.
the treatment times of the different stages of the process.

Following these studies we made quantitative and qualitative tests of the adhesion of the metal to the substrate using the Scotch tape test and pull tests followed by thermal shock tests on several samples, plasma treated under the operative conditions defined earlier (T1 to T4).

We thus used two Enthone metallisation baths of different compositions, that is to say with different proportions of solutions A, B to mix.

| | Plastic bath | Standard bath |
|---|---|---|
| Solution A | 50 cm³/l | 100 cm³/l |
| Solution B | 50 cm³/l | 100 cm³/l |
| Distilled water | 900 cm³/l | 800 cm³/l |

For each type of bath we prepared solutions with different pH:

| | Plastic bath | Standard bath |
|---|---|---|
| PH | 5.4 | 5.4 |
| | 6.2 | 6.0 |
| | 6.4 | 6.2 |

Visually, all samples are metallised homogenously over their entire surface, no blistering appeared.

The standard bath permits a higher deposition rate than the plastic bath: The pH has an important effect on the deposition rate: When the pH is increased from 5.4 to 6.2 in the standard bath, the deposition rate increases by 20%. As the pH is increased the deposition rate increases also. If the pH is increased to values greater than 8, it is possible to deposit up to 20 μm of metallic deposit in less than an hour. The adhesion of the deposition remains very sound and no blistering was evident. Several industrial baths were tested, for example one made by MacDermid-FRAPPAZ Europlate Ni 810 containing a higher phosphorus level than the Enthone model, and thus having better corrosion resistance. Similar results were obtained.

In order to improve the process further, several more methods of cleaning the sample surface were tested:
Stripping by treatment under O₂ plasma;
Alkaline cleaning in a concentrated NaOH solution, followed by neutralisation with an acid solution (immersion in an acetic acid solution) then rinsing with water;
Classic cleaning with isopropanol and immersion in the ultrasound bath.

We conducted the 3 cleaning types in parallel in order to compare their efficacy for PBT and LCP.

No significant difference as revealed in the quality of deposits obtained with the different surface treatments.

The priming for metallisation in the Electroless bath is an optional stage for the invention. It is possible to prime the baths so that the metallisation of the treated substrate may begin in the solution.

According to certain tests several samples immersed in an unprimed bath were not metallised correctly, a zone of greater or lesser size, in certain cases representing 90% of the sample surface displayed an absence of nickel. This problem was noted for all the chemical nickel or chemical copper baths tested. A first solution to this problem consisted in immersing in the solution a nickel panel freshly stripped in an HCl solution. Under these conditions, the presence of a large catalytic surface in the bath enables the oxidation-reduction reaction to begin since the bath is adjusted automatically to the appropriate oxidation-reduction potential for the reaction. It is evidenced by a release of hydrogen gas on the substrate. Metallisations carried out after the bath was primed, yielded homogenous metallisation of samples and a reproducibility of 100%.

The importance to the quality of the deposit of immersion times in the various baths for the Electroless metallising process was confirmed.

By running tests for different immersion times in the hypophosphite and formaldehyde, we confirmed the effect of this treatment on the initialisation time of the nickel deposition. It was noted that the nature of the polymer was a critical factor in the final metallisation of the substrate.
for LCP, the minimum immersion time is 20 seconds, with shorter times the metallising of the substrate is not homogenous;
for PBT, the minimum immersion time is 60 seconds, with shorter times some samples were poorly metallised.

This constraint may also be used for the selective metallisation of bi-component items, by limiting the metallising time to a time between these two different times, and possibly in combination with other choices.

FIG. 1 shows the evolution of the energy position of the 3d spin doublet of the palladium depending on the immersion time in the hypophosphite bath of PBT connector parts on which Pd²⁺ ions were chemisorbed. At time zero, the palladium is present in as Pd²⁺ and the energy location of the Pd 3d 5/2 peak is at 337.9 eV. As the immersion time in H₂PO₂⁻ increases, the energy location of this peak moves towards the weaker bonding energies, which corresponds to a reduction of Pd²⁺ in metallic Pd (0). The energy location of the metallic palladium peak Pd 3d 5/2 is located at 335.8 eV, which value is reached after 15 minutes' immersion of the PBT in H₂PO₂⁻. The comparative table below shows the energy locations of the Pd 3d 5/2 peak for different immersion times in H₂PO₂⁻ for Vectra and for PBT. It demonstrates the influence of the substrate on the rate of reduction of Pd²⁺ and shows that the Vectra is more active than PBT since at the end of 3 minutes a significant fraction of Pd²⁺ is reduced to Pd (0), the maximum of the peak envelope is displaced by 0.9 eV.

If we observe the parameters below systematically, we obtain correct metallisation with a reproducibility of 100%. In conclusion, a bath must be used with an operating temperature in the order of 60° C., ideally from 62° C. to 63° C., the bath must preferably be primed, the immersion time in the PdCl₂ bath is at least 2 minutes; in the H₂PO₂⁻ bath, for LCP: 20 secs, for PBT: 60 secs. By choosing 40 secs for example, this method of differentiation also enables metallising to be done separately on different parts of the same item in different plastic materials.

We then performed the adhesion of the metallic deposits on the different high temperature plastic substrates. The deposits were made on substrates of PBT and LCP, SPS and PPS on which we performed a surface treatment according to the ideal conditions determined and described above:

This treatment processing enables Electroless nickel metallisation in accordance with the indications specified above. Several deposits were made one after the other on substrates treated so as to replicate the structure of the electronic components. We then made chemical deposits, by Electroless means, followed by electrochemical deposits. The deposits were of nickel or copper; these are metals used in connection technology in the manufacture of electronic components, because they are good conductors.

The samples that were metallised in this way were subjected to adherence tests: Scotch tape test, pull test and thermal shocks.

The pull test enables the adhesion stresses measured on each sample to be compared with the adhesion stress prescribed by industrial standards which stipulate that the deposit withstand a minimum adhesion stress of 1.2 N/mm² for a connection application.

In order to study the adhesion of the metallic layers on PBT we analysed the influence of the gas type used in the plasma treatment, then the influence of the thickness of the chemical nickel deposited in the first layer, and also the influence of the copper type layer.

The following shows some examples of the tests performed on connector materials:

| TYPE 1 | TYPE 2 | TYPE 3 |
|---|---|---|
| electro Ni | | |
| chemical Ni | electro Ni | electro Ni |
| chemical Cu | electro Cu | electro Cu |
| chemical Ni | chemical Ni | chemical Ni |
| PBT and NH₃ plasma | PBT and N₂ plasma | PBT and NH₃ plasma |

The samples of the first type were prepared as follows:
Flash of chemical nickel of 0.3 μm
Deposit of chemical copper of 6.5 μm
Layer of chemical nickel of 0.25 μm (protection against the oxidation of the copper)
Second deposit of electrochemical nickel of 5.2 μm for a final thickness of 12.25 μm.

Samples of the second type were prepared as follows:
Deposit of chemical nickel from 0.87 μm to 4.58 μm
Deposit of electrochemical copper from 6 μm to 9 μm
Second deposit of electrochemical nickel of 5.2 μm for a final thickness between 12 μm and 16 μm.

Samples of the third type were prepared as follows:
Deposition of chemical nickel from 0.3 μm to 4.6 μm
Deposition of electrochemical copper from 6 μm to 15 mμ
Second deposit of electrochemical nickel of 5.2 μm to obtain a final thickness between 11 μm and 20 μm.

We performed the pull test on all samples.

All samples returned satisfactory results for all tests conducted, the pull tests being greater than the minimum stress accepted for these kinds of parts.

The results are summarised in the following tables, table 1 first type, table 2 second type, and table 3 third type, show adhesion stress values greater than the standard regardless of the initial thickness of nickel and regardless of the thickness of the electrochemical copper thickness added. The lowest adhesion stresses were observed for the greatest total thicknesses, effectively the thicker the deposit the greater are the internal stresses and the more the deposit is stressed with the risks of cohesive rupture.

TABLE 1
TYPE 1

| | | | | | Electro | | | | |
|---|---|---|---|---|---|---|---|---|---|
| | | chemical | chemical | chemical | Chemical | Total | ASTM D 5179 | ISO 2409 | DIN 53496 |
| | NH₃ | Nickel | Copper | Nickel | Nickel | thickness | Adhesion Test | Scotch test | Thermal |
| Substrate | Plasma | (μm) | (μm) | (μm) | (μm) | (μm) | (N/mm²) | (Hold as %) | shock test |
| PBT | 200 sccm, | 0.3 | 6.5 | 0.25 | 5.2 | 12.25 | >3.1 | 100 | Withstands |
| | 25 Pa, | | | | | | | | 100% |
| LCP | 180 W, | 0.3 | 6.5 | 0.25 | 5.2 | 12.25 | >1.2 | 95 | Withstands |
| | 90 | | | | | | | | 100% |
| SPS | seconds | 0.3 | 6.5 | 0.25 | 5.2 | 12.25 | >1.8 | 100 | Withstands |
| | | | | | | | | | 100% |

TABLE 2
TYPE 2

| | | | Electro | Electro | | | | |
|---|---|---|---|---|---|---|---|---|
| | | chemical | Chemical | Chemical | Total | ASTM D 5179 | ISO 2409 | DIN 53496 |
| | Plasma | Nickel | Copper | Nickel | Thickness | Adhesion test | Scotch test | Thermal |
| Substrate | N₂ + Ne | (μm) | (μm) | (μm) | (μm) | (N/mm²) | (Hold in %) | shock test |
| PBT | 200 sccm, | 0.87 | 9 | 5.2 | 15.07 | >2.6 | 100 | Withstands |
| | 25 Pa, | | | | | | | 100% |
| PBT | 180 W, | 4.58 | 6 | 5.2 | 15.78 | >2.4 | 100 | Withstands |
| | 90 | | | | | | | 100% |
| LCP | seconds | 0.87 | 9 | 5.2 | 15.07 | >1.2 | 100 | Withstands |
| | | | | | | | | 100% |
| LCP | | 4.58 | 6 | 5.2 | 15.78 | >1.1 | 90 | Withstands |
| | | | | | | | | 95% |

TABLE 3
TYPE 3

| | | | Electro | Electro | | | | |
|---|---|---|---|---|---|---|---|---|
| | | Chemical | Chemical | Chemical | Total | ASTM D 5179 | ISO 2409 | DIN 53496 |
| | Plasma | Nickel | Copper | Nickel | Thickness | Adhesion test | Scotch test | Thermal |
| Substrate | NH₃ | (μm) | (μm) | (μm) | (μm) | (N/mm²) | (Hold in %) | Shock Test |
| PBT | 200 sccm, | 0.35 | 15 | 5.2 | 20.55 | >2.1 | 100 | Withstands |
| | 25 Pa, | | | | | | | 100% |
| PBT | 180 W, | 1.5 | 10 | 5.2 | 16.7 | >2.3 | 100 | Withstands |
| | 90 | | | | | | | 100% |
| PBT | seconds | 4.6 | 6 | 5.2 | 15.8 | >2.45 | 100 | Withstands |
| | | | | | | | | 100% |
| SPS | | 0.35 | 15 | 5.2 | 20.55 | >2.05 | 100 | Withstands |
| | | | | | | | | a 95% |
| SPS | | 1.5 | 10 | 5.2 | 16.7 | >1.9 | 100 | Withstands |
| | | | | | | | | 100% |
| SPS | | 4.57 | 6 | 5.2 | 15.77 | >1.7 | 100 | Withstands |
| | | | | | | | | 100% |

For each sample, the initial thickness of nickel observed does not significantly influence the maximum adhesion stress value. The Scotch tape tests and the thermal shocks yield similar, positive results that confirm the previous results and confirm that the process according to the invention creates a true graft of attachment sites for the metal on the plastic substrate.

Similarly if we consider a thickness of electrochemical copper of 6 μm, we observe that the initial thickness of nickel does not affect the value of the maximum adhesion stress.

We even carried out repeated activations, before metallisation, in cycles, each cycle including exposure of the item for 60 seconds (or another period) to a plasma chosen from those previously described, ionic immersion for 2 minutes (or another period) for grafting palladium, and immersion for 3 minutes (or another period) in a hypophosphite bath. Different results may then be obtained, depending on the nature of the following operations, and depending on the materials to be metallised.

On the other hand, for pieces in two parts created by sandwich moulding of a first plastic material by a second plastic material, and because the remoulding is done twice, the effect of the waiting time after activation and before the palladium grafting was considered. In fact, the moulded parts are first cast in one workshop of the factory, activated in another workshop of the factory, and are returned to the first workshop for remoulding.

Within the scope of the invention, the effects of waiting before grafting due to such, an industrial process were studied. It was determined that after fifteen days, LCP samples were completely deactivated, PBT samples were 50% deactivated, but that SPS samples were successfully metallised. This loss of activation means that it is possible to make fully activated bi-material products, for example LCP-SPS, and then wait for 15 days (or another period), before the whole is metallised. In this way, the SPS parts may be metallised selectively. The form of the mechanical structure is sufficient to separate the metallised zones pin SPS from the non-metallised zones in LCP.

Similarly, the effect of the metallisation time and stirring the metallisation bath enables the metallising to be differentiated, a comparison of PPS and LCP at the time of the metallisation in a bath with mixing reveals that PPS requires 120 seconds for metallisation, whereas LCP reacts in the metallisation bath after 5 to 10 seconds. Thus according to one embodiment of the invention, hybrid PPS-LCP samples are activated, immersed in the metallisation bath for no more than 15 seconds, and removed from the bath so that ultimately only the LCP is metallised. There too, the mechanical structure is sufficient to separate the metallised zones from the non-metallised zones without using material provided with catalytic charges nor including a metallisation precursor.

In the event that stirring the metallisation bath is stopped, the metallising of PPS and LCP is immediate. In practice, stirring the bath retards the metallisation of PPS if the stirrer speed is greater than 500 rpm. This is because stirring introduces oxygen into the metallising solution. Oxygen poisons the catalytic nuclei on the surface of the item made from plastic material. An excess of oxygen deactivates the metallisation of the plastic since the palladium is then either poisoned or oxidised. This occurs with PPS, and to a lesser degree with LCP which includes an excess of catalytic sites.

The excess air can however slow the metallisation of LCP. If nitrogen is substituted for oxygen, the two items are metallised without difficulties.

The metallisation bath used is for example an ENPLATE NI 426 bath made by Enthone OMI.

Thus besides the duration, in this case a parameter is available concerning the stirring speed and/or the temperature of the bath to encourage selective metallisation.

As a consequence, the use of different high temperature polymer materials, for example PBT or PPS as materials not susceptible to metallising in conjunction with SPS or LCP, which are suitable for metallising, the invention permits enables items of the Molded Interconnect Devices type to be made. The forms on the surface of the item parts in these different materials represent respectively zones that are not to be metallised and zones that are.

The selectivity parameters for differential metallisation are as follows, certain of which may be used together in combination, or individually:
the nature of the activation plasma,
the completion of one or more activation cycles before grafting,
the waiting period after activation and before grafting,
the duration of the metallising stage,
the stirring rate of the metallisation bath,
the temperature of the metallisation bath,
the nature of the metallisation metal (nickel or copper).

All these parameters can be adapted according to the nature of the bi-component high temperature polymer materials retained and the type of metallising sought. These processes are also compatible under the same conditions as before with remoulding techniques followed by subsequent metallisation.

One example of a metallised bi-materials item is represented schematically in FIGS. 2A, 2B, 2C, the first material 1 to be metallised is moulded in a first place, the second material 2, which must not react to the metallising, is remoulded on the first material leaving zones 3 of the first material exposed. The unit is then activated by nitrogenous plasma creating a surface provided with activated sites.

FIG. 3 shows a partial cross-section of a selective metallisation zone having two metallic layers 5, 6 in which some zones have been suppressed in order to allow analysis of the metal-plastic interface 4.

FIG. 4 shows the general spectral curve yielded by photoelectron spectrometry (ESCA or XPS analysis) after NH₃ Plasma metallisation, 200 sccm, 20 Pa, 200 W, 40 sec of an LCP substrate. This general spectrum shows a number of peaks, peak 8 being representative of the presence of nitrogenous moieties, and peaks 7 and 9 being representative of carbon and oxygen moieties respectively.

A detail of the curve in FIG. 5, centred on peak 8 allows three sub-peaks 10, 11, 12 to be characterised, which are due to the nitrogenous activation plasma.

FIG. 6 shows a detail, centred on the energy zone of the palladium, of a curve obtained on a PPS substrate by the metallisation process according to the invention. This detail reveals two peaks 13, 14 common to the palladium, showing a representative shift of palladium/nitrogen bonds that is effected by the process according to the invention, corresponding to a statistical analysis shown in FIG. 7.

FIG. 8 represents a schematic view of a part created by the process according to the invention, for which a plastic material 20 has been metallised. This part 20 may be for example a half-housing including a rim 26, an external circumference 27, one or more contact blocks 28, an internal partition 29, an external surface 30, an internal surface 31.

This housing includes metallised zones 21, 22, 23a to 23c, 24, 25, 32, zone 21 forms a part of the insulation, zones 24 are metallised connection paths, zones 23a to 23c are internal contact blocks connected to insulation 21 by metallised traversing holes 22, these contact blocks for internal connection allowing the provision of earthing points or heat sink contact blocks, zone 25 forming an extension of zone 21 to create an external earth connection.

In order to process this part, the housing, moulded for example in a material such as PBT, is covered beforehand on the zones that are not to be metallised such as rim 26 and outside circumference 27 with one or more masking elements such as are known in the prior art, and then placed in the plasma activation apparatus. Because of the process according to the invention, even the hidden zones such as the traversing holes are activated and may be included in the palladium graft and the creation of palladium-nitrogen bonds to form attachment sites for the metallisation when immersed in the palladium bath.

The part is then immersed in the metallisation bath or a series of metallisation baths to obtain the metallised layers described previously according to the thicknesses suitable for the desired insulation function or the function of current conduction.

In order to reduce the complexity of the masking operation, it is possible to metallise internal face 31 uniformly, paths 24 may then be created and contact blocks 23a to 23c may be isolated on this internal face 31 in a supplementary stage of laser structuring.

Thus the process and parts obtained thereby may be realised in a flexible manner and in less time than processes according to the prior art and in “high temperature” materials adapted to industrial use with a high technical component.

1-13. (canceled)

14. Process for metallizing an article comprising a first high temperature polymer material, including the following steps:
a) cleaning and degreasing the article;
b) activating by etching the article surface with a plasma gas;
c) grafting the activated surface with metallic atoms;
d) metallizing the grafted surface by immersing the article in a chemical metallizing bath at a temperature ranging from 50 to 70° C.

15. Process according to claim 14, wherein the plasma gas is nitrogenous plasma gas.

16. Process according to claim 15, wherein the plasma gas is chosen among N2, NH3 or N2+H2 or a mixture thereof.

17. Process according to claim 16, wherein the plasma gas further includes an inert gas.

18. Process according to claim 1, wherein the metallic atom is chosen among a metal of group VIII.

19. Process according to claim 18, wherein the metallic atom is palladium.

20. Process according to claim 19, wherein the step c) consists of immersing the plasma treated article in a metallization bath comprising palladium ions.

21. Process according to claim 20, wherein the metallization bath is PdCl2 or PdSO4 bath.

22. Process according to claim 1, wherein prior to step d), the activated article is treated with a reducing chemical bath.

23. Process according to claim 22, wherein the reducing chemical bath comprises hypophosphite, formaldehyde or hydrosulphite as reducing agent.

24. Process according to claim 14, wherein the high temperature polymer material is chosen among semi-crystalline polymers or liquid crystal polymers or polybutylene terephthalate (PBT) or polyphenylene Sulphide (PPS) or syndiotactic polystyrene (SPS).

25. Process according to claim 14, wherein prior to step a) or after step a) the first high temperature polymer material is partially moulded with a further polymer material to expose a portion of the first high temperature polymer material.

26. Process according to claim 14, wherein after step b), the first high temperature polymer material is partially overmoulded with a further polymer material to expose a portion of the first high temperature polymer material.

27. Process according to claim 25, wherein process parameters are chosen so as to only enable metallization of the exposed portion of the first high temperature polymer material.

28. Process according to claim 26, wherein process parameters are chosen so as to only enable metallization of the exposed portion of the first high temperature polymer material.

29. Process according to claim 27, wherein the process parameters are chosen among:
number of activation cycles before grafting
duration of metallizing step
stiring rate of the metallization bath
temperature of the metallization bath
chemical composition of the metallization bath.

30. Process according to claim 28, wherein the process parameters are chosen among:
number of activation cycles before grafting
duration of metallizing step
stiring rate of the metallization bath
temperature of the metallization bath
chemical composition of the metallization bath.

31. Process according to claim 14, wherein the chemical metallizing bath is a nickel or copper bath.

32. Metallized article obtained by the process according to claim 14 or claim 25 or claim 26.
